(19) United States
(12) Patent Application Publication
(10) Pub. No.: US 2026/0293914 A1
(43) Pub. Date: Oct. 1, 2026

(54) NOODLE SKIN PIECE PRODUCING APPARATUS

(71) Applicant: YUTAKA MFG. CO., LTD., Kounan-shi (JP)

(72) Inventors: Masayasu KURACHI, Kounan-shi (JP); Hideto OMI, Kounan-shi (JP)

(73) Assignee: YUTAKA MFG. CO., LTD., Kounan-shi (JP)

(21) Appl. No.: 19/545,172

(22) Filed: Feb. 20, 2026

(30) Foreign Application Priority Data
Mar. 31, 2025 (JP) 2025-058161

(51) Int. Cl. A21C 11/10; A21C 9/04; A21C 9/08

(52) U.S. Cl. CPC A21C 11/10; A21C 9/04; A21C 9/085

(57) ABSTRACT

A noodle skin piece producing apparatus includes a mold roller, one or more conveyor apparatuses and a separating cutter. The mold roller has a substantially cylindrical-shaped outer peripheral surface pressed against a noodle band and is formed with a female mold in the outer peripheral surface to form a convex portion in a noodle band. The separating cutter is for cutting off a region of the noodle band including the formed convex portion conveyed by the conveyor apparatus as a noodle skin piece. A surface concave portion is formed in a region in the outer peripheral surface of the mold roller different from the female mold.

### CROSS-REFERENCE TO RELATED APPLICATIONS

This application claims priority to Japanese patent application serial number 2025-058161, filed on Mar. 31, 2025, the content of which is incorporated herein by reference in its entirety for all purposes.

### TECHNICAL FIELD

The present disclosure relates to a noodle skin piece producing apparatus having a mold roller.

### BACKGROUND

A noodle skin piece producing apparatus has been disclosed that cut off a region including a convex portion from a noodle band so as to produce a noodle skin piece. The convex portion is formed in the noodle band by pressing a mold roller with a female mold formed therein against the noodle band (see, for example, Japanese Patent Application Laid-Open No. 2024-122048).

### SUMMARY

However the inventors found that unintended deformation (for example, wrinkles in the surface of the noodle band and/or serpentine deformation of the noodle band) may occur in the noodle band during forming the convex portion by pressing the mold roller provided in the above-described producing apparatus against the noodle band. The serpentine deformation of the noodle band (i.e., meandering) may occur due to the noodle band deflecting in the width direction while pressed by the mold roller. If unintended deformation occurs in the noodle band, it may hinder the production of the noodle skin pieces with the intended shape.

In view of the foregoing, one object of the present disclosure is to disclose a noodle skin piece producing apparatus that can suppresses unintended deformation of the noodle band during forming of convex portions by pressure of the mold rollers, thereby enabling the production of the noodle skin pieces with the intended shape.

A noodle skin piece producing apparatus for achieving the above-described object (hereinafter also referred to as “the present apparatus”) comprises a mold roller, at least one conveyor apparatus and a separating cutter. The mold roller has a substantially cylindrical-shaped outer peripheral surface and configured to rotate about an axis line of the cylindrical shape, wherein the outer peripheral surface includes a female mold configured to form a convex portion in a noodle band when the outer peripheral surface is pressed against the noodle band. The at least one conveyor apparatus is configured to convey the noodle band having the convex portion formed therein. The separating cutter is configured to cut off a region of the noodle band including the convex portion conveyed by the at least one conveyor apparatus as a noodle skin piece. The outer peripheral surface of the mold roller includes a surface concave portion recessed radially (inward) in a region distinct from the female mold, the surface concave portion being configured to receive a portion of the noodle band to reduce pressure applied to the noodle band.

The mold roller according to the present apparatus has the surface concave portion formed therein, in addition to the female mold to form the convex portions. Consequently, when the mold roller rotates and its outer peripheral surface presses against the noodle band, a part of the noodle band (more specifically, the dough constituting the noodle band) enters the female mold, while another part of the noodle band enters the surface concave portion. As a result, since the pressure acting on the noodle band is decreased during pressed by the mold roller, the occurrence of unintended deformation is suppressed. Therefore, according to the present apparatus, the possibility of producing the noodle skin pieces with the intended shape is increased.

In one aspect (first aspect) of the present apparatus, the surface concave portion includes a circumferential groove centered on the axis line of the mold roller.

According to the first aspect, a part of the noodle band enters the circumferential (circular) groove during pressed by the mold roller with the outer peripheral surface, thereby reducing the pressure acting on the noodle band. This suppresses the occurrence of unintended deformation in the noodle band.

In still another aspect (second aspect) of the present apparatus, the separating cutter is detachably fixed to a rotational shaft, its cutting edge contacting the noodle band during rotation with the rotational shaft.

In the second aspect, since the separating cutter cuts off the noodle skin piece from the noodle band while rotating, it is not necessary to stop the conveyor apparatus when cutting off the noodle skin piece from the noodle band. Therefore, according to the second aspect, the process of cutting off the noodle skin piece from the noodle band can be performed efficiently.

In still another aspect (third aspect) of the present apparatus, the separating cutter is composed of hardened steel material, and its cutting edge is formed by grinding process.

According to the third aspect, the separating cutter with a sharp cutting edge and high durability can be relatively easily manufactured.

In still another aspect (fourth aspect) of the present apparatus, the present apparatus further comprises an angle acquisition part and a controller. The angle acquisition part is for acquiring an angle correlation value having a correlation with a rotational angle of the mold roller. The controller is configured to control the rotational angle of the separating cutter in accordance with the angle correlation value. The controller may be implemented by at least one programmed processor whose operation is determined by a predetermined program, gate arrays and the like.

In the fourth aspect, since the rotational angle of the separating cutter is controlled corresponding to the rotational angle of the mold roller, the intended region within the noodle band is more likely to be cut off as a noodle skin piece by the separating cutter. Therefore, according to the fourth aspect, the likelihood of producing noodle skin pieces with the intended shape is increased.

### BRIEF DESCRIPTION OF THE DRAWINGS

FIG. 1 is a schematic configuration diagram of a noodle skin piece producing apparatus according to a first embodiment.

FIG. 2 is a front view of the mold roller provided in the noodle skin piece producing apparatus.

FIG. 3 is a perspective view of a portion of the noodle band with convex portions formed by the mold roller.

FIG. 4(a) shows a shape of the convex portion formed by the mold roller in the noodle band. FIG. 4(b) shows a shape of the noodle skin piece separated from the noodle band. FIG. 4(c) shows a shape of the noodle skin piece shipped as a product.

FIG. 5 is a perspective view of a cutter provided in the noodle skin piece producing apparatus.

FIG. 6 is a cross-sectional view of the cutter.

FIG. 7 is a timing chart showing a sequential operation of each cutting apparatus equipped with the cutter.

FIG. 8 is a front view of a mold roller according to a first modification of the first embodiment.

FIG. 9 is a schematic configuration diagram of a noodle skin piece producing apparatus according to a second embodiment.

### DETAILED DESCRIPTION

### First Embodiment

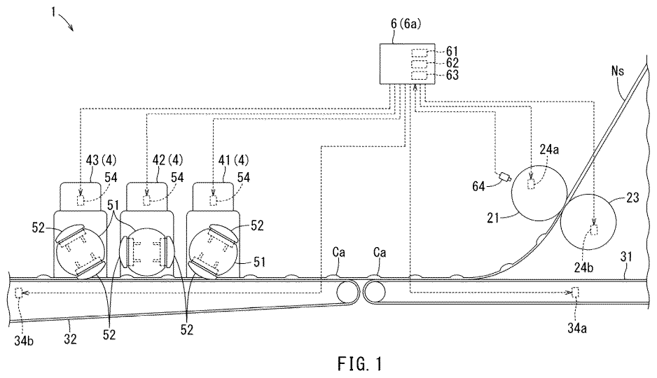

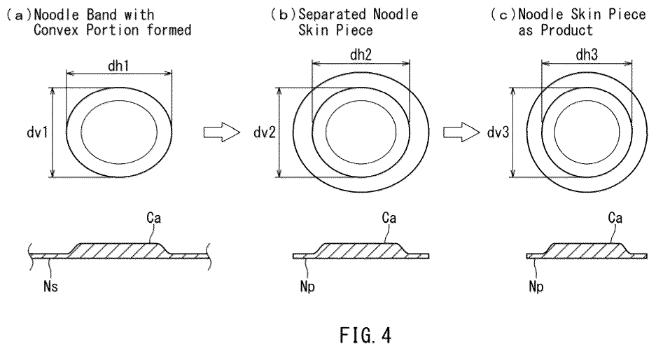

A first embodiment of the present disclosure will be described with reference to FIGS. 1 to 7. FIG. 1 schematically illustrates a noodle skin piece producing apparatus 1 (also simply referred to as the producing apparatus 1) according to the first embodiment. The producing apparatus 1 is configured to cut off a noodle skin pieces Np (see FIG. 4) from a noodle band Ns. The noodle band Ns is dough containing wheat flour and water, formed into a strip shape. Consequently, the noodle skin pieces Np are grain-based processed food products, used for example as dumpling (gyoza) wrappers.

The producing apparatus 1 includes a mold roller 21, a press roller 23, conveyor apparatuses 31 and 32, and cutting apparatuses 4, and is controlled by a controller 6. The controller 6 comprises a known control device (for example, a general-purpose computer or an electronic control unit) including a CPU 61, RAM 62, and non-volatile memory 63. The non-volatile memory 63 stores programs executed by the CPU 61, and parameters referenced by the CPU 61 during execution of the programs.

Each of the mold roller 21 and the press roller 23 has a substantially cylindrical outer peripheral surface and is rotatably supported. More specifically, a predetermined gap is provided between the outer peripheral surface of the mold roller 21 and the outer peripheral surface of the press roller 23. Each of the mold roller 21 and the press roller 23 is rotated in opposite directions by electric motors 24a and 24b (for example, servo motors) controlled by the controller 6. Descriptions of mechanisms or devices for transmitting the torque from the electric motors 24a-24b to the mold roller 21 and the press roller 23 are omitted from the illustration and description.

Multiple female molds 21a and circumferential grooves 21b are formed in the outer peripheral surface of the mold roller 21. The specific shapes of the female molds 21a and the circumferential grooves 21b, and their arrangement in the mold roller 21 will be described later. The noodle band Ns is inserted between the mold roller 21 and the press roller 23, which are rotating, whereby the noodle band Ns is rolled forward. Additionally, the female molds 21a and the circumferential grooves 21b form (mold) the surface of the noodle band Ns on the side facing the mold roller 21 while the outer peripheral surface of the mold roller 21 in rotation is pressed against the surface of the noodle band Ns. Specially, the female molds 21a form convex portions Ca on the noodle band Ns.

The noodle band Ns with the convex portions Ca formed therein is transported by conveyor apparatuses 31 and 32 to a section under the cutting apparatuses 4. The conveyor apparatuses 31 and 32 are driven by electric motors 34a and 34b, respectively. The controller 6 controls the electric motors 34a-34b such that the conveyor apparatuses 31-32 move the noodle band Ns forward in accordance with the speed at which the mold roller 21 and the press roller 23 roll out the noodle band Ns. Descriptions of mechanisms or devices for transmitting torque from the electric motors 34a-34b to the conveyor apparatuses 31 and 32 are omitted from the illustration and description.

Each region of the noodle band Ns containing the convex portion Ca is cut off by the cutting apparatuses 4 as a noodle skin piece Np. Each of the noodle skin pieces Np is further transported by the conveyor apparatus 32 to undergo subsequent processes, including packaging. Meanwhile, a residual portion of the noodle band Ns, from which the noodle skin pieces Np have been cut, is generated. The residual portion of the noodle band Ns is transported upward above the conveyor apparatus 32 by a residual portion conveyor apparatus (not shown) and subsequently aggregated for reuse.

It should be noted that the producing apparatus 1 further includes a plurality of powder dispersing apparatuses (not shown). One of the powder dispersing apparatuses disperses powder (for example, potato starch) onto the noodle band Ns before the noodle band Ns is inserted between the mold roller 21 and the press roller 23. Another powder dispersing apparatus disperses powder onto the conveyor apparatus 31 before the noodle band Ns is placed thereon. The dispersed powder prevents the noodle band Ns from adhering to the outer peripheral surface of the mold roller 21 (particularly, the female molds 21a and circumferential grooves 21b) or to the conveyor apparatuses 31 and 32.

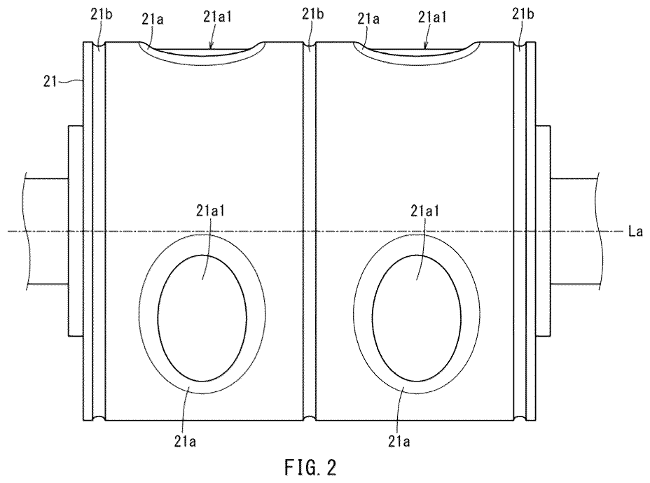

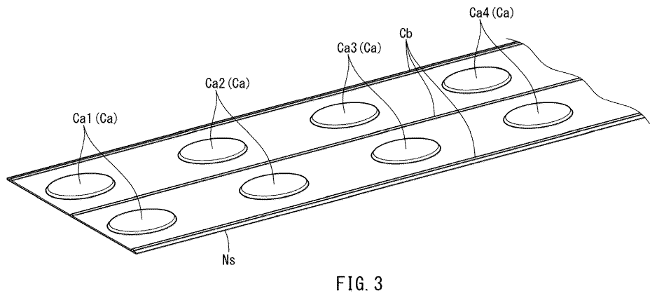

Referring to FIG. 2, the female molds 21a and circumferential grooves 21b in the mold roller 21 are described. Six of the female molds 21a are formed in the outer peripheral surface of the mold roller 21. More specifically, two female molds 21a are formed at 120° intervals relative to an axis line La, which is the rotational center of the mold roller 21. Each of the female molds 21a has a bottom surface 21a1. The depth of the female mold 21a decreases from the peripheral portion of the bottom surface 21a1 toward the peripheral portion (outer portion) of the female mold 21a. The noodle band Ns, pressed (rolled) by the mold roller 21 and the press roller 23, includes pairs of the convex portions Ca arranged at substantially equal intervals in the extending direction, in which the noodle band Ns is rolled out from the gap between the mold roller 21 and the press roller 23 (see FIG. 3).

In addition, three circumferential grooves 21b are formed in the outer peripheral surface of the mold roller 21. Each of the circumferential grooves 21b is a ring-shaped groove centered on the axis line La of the mold roller 21. In other words, the circumferential groove 21b is a groove extending in the circumferential direction on the outer peripheral surface of the mold roller 21 and having no end points. Therefore, the noodle band Ns pressed by the mold roller 21 and the press roller 23 includes three semicylindrical protrusions Cb formed therein, which extend in the extending direction (see FIG. 3).

Since the circumferential grooves 21b are formed on the mold roller 21, the pressure acting on the noodle band Ns is reduced when the noodle band Ns is pressed by the mold roller 21 and the press roller 23. More specifically, the circumferential groove 21b formed on the mold roller 21 increases the area (cross-sectional area) of the gap between the mold roller 21 and the press roller 23, thereby facilitating the entry of the noodle band Ns into the gap between the mold roller 21 and the press roller 23. If the noodle band Ns does not smoothly enter between the mold roller 21 and the press roller 23, or if a part of the noodle band Ns is temporarily pushed out in the direction opposite to the extending direction, the possibility of wrinkles forming in the noodle band Ns or meandering of the noodle band Ns increases.

In other words, the circumferential grooves 21b formed on the mold roller 21 suppress unintended deformation of the noodle band Ns during pressing by the mold roller 21 and the press roller 23. Each of the circumferential grooves 21b is a recess formed in a region of the outer peripheral surface of the mold roller 21 (more specifically, the region contacting the noodle band Ns) that is different from the female mold 21a. Each of the circumferential grooves 21b is also referred to as a “surface concave portion” for convenience.

The shape of the convex portions Ca in the noodle band Ns immediately after being formed by pressing with the mold roller 21, including the female mold 21a, and the press roller 23 is shown by the top view and the cross-sectional view in FIG. 4(a). As understood from FIG. 4(a), an extending length and a width length of this convex portion Ca are substantially equal to a length dh1 and a length dv1, respectively. The extending length of the convex portion Ca is the length of the convex portion Ca in the extending direction of the noodle band Ns. The width length of the convex portion Ca is the length of the convex portion Ca in the width direction of the noodle band Ns (i.e., the direction perpendicular to the extending direction).

This convex portion Ca on the noodle band Ns has a substantially elliptical shape when viewed from above. More specifically, the length dh1 is greater than the length dv1 (i.e., dh1>dv1). The ratio of the length dh1 (i.e., the extending length) to the length dv1 (i.e., the width length) is also referred to as an ellipticity ratio Ea (i.e., Ea=dh1/dv1>1).

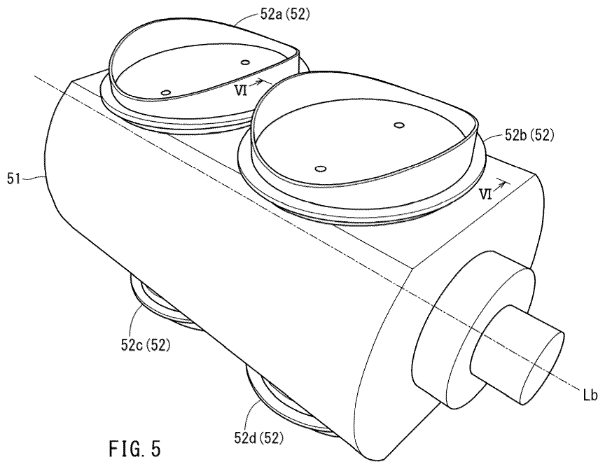

The cutting apparatus 4 includes a front cutting apparatus 41, a middle cutting apparatus 42, and a rear cutting apparatus 43 (see FIG. 1). Each of the front cutting apparatus 41, middle cutting apparatus 42, and rear cutting apparatus 43 includes a rotational shaft 51 and four cutters 52 (see FIG. 5). Each of the cutters 52 is fixed (fastened) to the rotational shaft 51 by bolts. FIG. 5 shows a pair of bolt holes formed in each of the cutters 52, while the bolts themselves are omitted from the illustration. The cutter 52 is referred to as a “separating cutter” for convenience.

Two pairs of the cutters 52 are arranged on the rotational shaft 51 on opposite sides relative to an axis line Lb of the rotational shaft 51 (see FIG. 5). More specifically, cutters 52a-52b are arranged as a pair. In addition, cutters 52c-52d are arranged as a pair on the opposite side from the cutters 52a-52b.

The rotational shaft 51 is rotated by an electric motor 54 (for example, a servo motor) controlled by the controller 6. Descriptions of mechanisms or devices for transmitting torque from the electric motor 54 to the rotational shaft 51 are omitted from the illustration and description. As the cutter 52 rotates with shaft 51, the tip portion of the cutter 52 (i.e., the cutting edge, the cutting blade) contacts the noodle band Ns, creating a substantially elliptical cut (a deep notch) around the convex portion Ca in noodle band Ns. As such, the noodle skin piece Np is separated from noodle band Ns. Specifically, each of the cutters 52 is a rotary cutter.

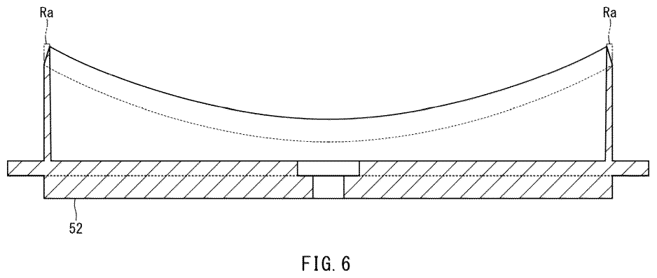

As understood from the cross-sectional view in FIG. 6, the tip portion of the cutter 52 has a sharp shape. A region Ra shown in FIG. 6 indicates the cross-sectional shape of the portion ground and removed away during the manufacturing process of the cutter 52. More specifically, the cutter 52 is composed of a hardened steel material. In addition, the cutter 52, which has a substantially elliptical shape, is formed by removing the tip portion of the cutter 52 corresponding to region Ra (i.e., the annular portion having a substantially elliptical shape) by grinding. During the manufacturing process of cutter 52, grinding is performed after quenching, but quenching may also be performed after grinding. It should be noted that the depiction of the sharpened cutting edge (i.e., the tip portion) of cutter 52 is omitted in FIG. 5.

The shape of the noodle skin piece Np immediately after being cut off by the cutter 52 is shown by the top view and the cross-sectional view in FIG. 4(b). As shown in FIG. 4(b), the extending length and the width length of the convex portion Ca contained in this noodle skin piece Np are substantially a length dh2 and a length dv2, respectively. The ratio of length dh2 to length dv2 is also referred to as an ellipticity ratio Eb (i.e., Eb=dh2/dv2).

Incidentally, the noodle band Ns contracts (shrinks) after being pressed by the mold roller 21 and the press roller 23. That is, the noodle band Ns gradually becomes smaller over time. Therefore, when the portion of the noodle band Ns including the convex portion Ca is cut off as a noodle skin piece Np by the cutter 52, the noodle band Ns with the convex portion Ca formed therein has contracted compared to immediately after being pressed by the mold roller 21 and the press roller 23. In addition, a contraction ratio in the extending direction of the noodle band Ns is smaller compared to the width direction. Consequently, the elliptical shape of the convex portion Ca in the top view as shown in FIG. 4(a) has changed approaching closer to a circular shape when the portion of the noodle band Ns including the convex portion Ca cut off by the cutter 52 as the noodle skin piece Np as shown in FIG. 4(b). That is, the ellipticity ratio Eb is smaller than the ellipticity ratio Ea (i.e., Ea>Eb).

Furthermore, the shape of the noodle skin piece Np shipped and distributed as a product in markets is shown by the top view and the cross-sectional view in FIG. 4(c). As shown in FIG. 4(c), the extending length and width length of the convex portion Ca contained in the noodle skin piece Np are substantially equal to a length dh3 and a length dv3, respectively. The ratio of length dh3 to length dv3 is also referred to as an ellipticity ratio Ec (i.e., Ec=dh3/dv3).

The convex portion Ca in the noodle skin piece Np shown in FIG. 4(c) has a substantially true circular shape when viewed from above (i.e., Eb>Ec≈1). In addition, the outer shape of the noodle skin piece Np shown in FIG. 4(c) also has a substantially circular shape when viewed from above. More specifically, the shape of the female mold 21a in the mold roller 21 and the shape of the cutter 52 in the cutting apparatuses 4 are adjusted in advance such that the noodle skin piece Np distributed in markets has a substantially circular shape when viewed from above. Therefore, the noodle skin piece Np shown in FIG. 4(b) has an elliptical shape in outline when viewed from above, and its ellipticity rate is substantially equal to the ellipticity ratio Eb.

Each of the cutting apparatuses 4 (i.e., the front cutting apparatus 41, the middle cutting apparatus 42, and the rear cutting apparatus 43) cuts off the noodle skin pieces Np from the noodle band Ns in this order. For example, after the region in the noodle band Ns including a pair of convex portions Ca1, which are the convex portions Ca shown in FIG. 3, are cut off as the noodle skin pieces Np by the front cutting apparatus 41, the region including a pair of convex portions Ca2 adjacent to the convex portions Ca1 in the extending direction are cut off as the noodle skin pieces Np by the middle cutting apparatus 42. Subsequently, the region including a pair of convex portions Ca3 adjacent to the convex portion Ca2 are cut off as the noodle skin pieces Np by the rear cutting apparatus 43. Furthermore, the region including a pair of convex portions Ca4 adjacent to the convex portion Ca3 are cut off as the noodle skin pieces Np by the front cutting apparatus 41.

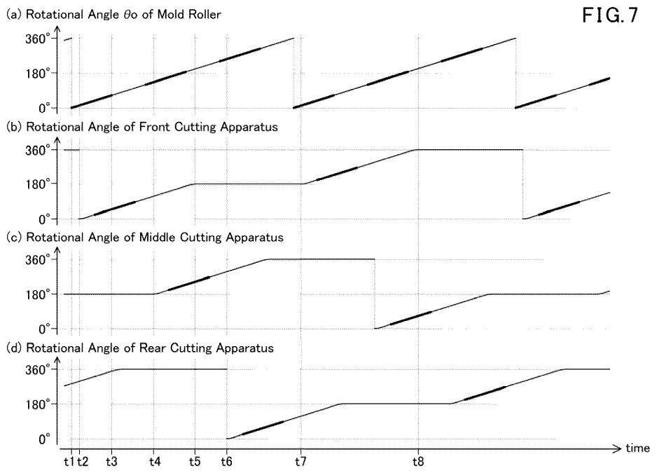

The procedure by which each of the cutting apparatuses 4 cuts off the noodle skin pieces Np over time is shown in FIG. 7. More specifically, the change in a rotational angle θo of the mold roller 21 is shown in FIG. 7(a). The section indicated by the thick line in FIG. 7(a) represents the time period during which a pair of the female molds 21a on the mold roller 21 are pressed against the noodle band Ns. For example, during the period from time t1 to time t3, two of the female molds 21a are pressed against the noodle band Ns.

The changes in rotational angles of each of the cutters 52 included in the cutting apparatuses 4 are shown in FIG. 7(b) to (d). The sections indicated by thick lines in FIG. 7(b) to (d) represent the time periods during which the tip portion (i.e., the cutting edge) of the cutter 52 is in contact with the noodle band Ns. As understood from FIG. 7(b) to (d), each of the cutters 52 included in the cutting apparatuses 4 stops after rotating by 180°. The control of the cutting apparatuses 4 by the controller 6 will be described later.

The rotational angle θo of the mold roller 21 is detected by a rotational angle sensor 64 (see FIG. 1). The controller 6 receives a signal indicative of the rotational angle θo from the rotational angle sensor 64 and controls the respective electric motors 54 associated with the cutting apparatuses 4 (i.e., the front cutting apparatus 41, the middle cutting apparatus 42, and the rear cutting apparatus 43) based on the rotational angle θo. The rotational angle θo is also referred to as the “angle correlation value” for convenience. The rotational angle sensor 64, which acquires the angle correlation value, is also referred to as the “angle acquisition part” for convenience.

More specifically, the controller 6 controls each of the electric motors 54 to alternate between operation and stoppage repeatedly. When the electric motor 54 is in the operating state, the rotational shaft 51 and cutter 52 rotate by 180° to cut off a pair of the noodle skin pieces Np from the noodle band Ns. That is, when the region of the noodle band Ns including the convex portion Ca approaches the cutter 52, the controller 6 switches the electric motor 54 corresponding to that cutter 52 to the operating state. Subsequently, the controller 6 switches the electric motor 54 to the stoppage state at the timing when that cutter 52 has rotated by 180°.

The controller 6 therein stores three rotational angles θo as configured rotational angles corresponding to each of the cutting apparatuses 4 set by an operator. When the rotational angle θo becomes equal to the configured rotational angle corresponding to the front cutting apparatus 41, the controller 6 switches the electric motor 54 corresponding to the front cutting apparatus 41 to the operating state. That is, the controller 6 rotates the cutter 52 of the front cutting apparatus 41 in accordance with the speed of the noodle band Ns conveyed to the extending direction by the conveyor apparatus 32. Similarly, when the rotational angle θo becomes equal to the configured rotational angle corresponding to the middle cutting apparatus 42 or the rear cutting apparatus 43, the controller 6 switches the electric motor 54 corresponding to the middle cutting apparatus 42 or the rear cutting apparatus 43 to the operating state.

As described above, the noodle band Ns contracts after being pressed by the mold roller 21 and the press roller 23. In other words, the spacing (distance) between adjacent convex portions Ca in the extending direction decreases due to the contraction of the noodle band Ns. The contraction ratio of the noodle band Ns varies depending on factors or parameters such as the components of the noodle band Ns (for example, the variety of wheat used and the moisture content) and the temperature of the noodle band Ns, among other factors. Therefore, the configured rotational angles of the cutting apparatuses 4 may be adjusted according to the contraction ratio of the noodle band Ns at that time.

In the example shown in FIG. 7, at the time t2, the rotational angle θo becomes equal to the configured rotational angle corresponding to the front cutting apparatus 41. Consequently, the controller 6 activates the electric motor 54 of the front cutting apparatus 41, causing the cutters 52 of the front cutting apparatus 41 to rotate by 180° during the period from the time t2 to the time t5. Subsequently, at the time t7, the rotational angle θo again becomes equal to the configured rotational angle corresponding to the front cutting apparatus 41. Consequently, the controller 6 rotates the cutters 52 of the front cutting apparatus 41 by 180° during the period from the time t7 to the time t8.

Similarly, since the rotational angle θo becomes equal to the configured rotational angle corresponding to the middle cutting apparatus 42 at the time t4, the controller 6 rotates the cutters 52 of the middle cutting apparatus 42 by 180°. In addition, at the time t6, since the rotational angle θo becomes equal to the configured rotational angle corresponding to the rear cutting apparatus 43, the controller 6 rotates the cutters 52 of the rear cutting apparatus 43 by 180°.

### First Modification of First Embodiment

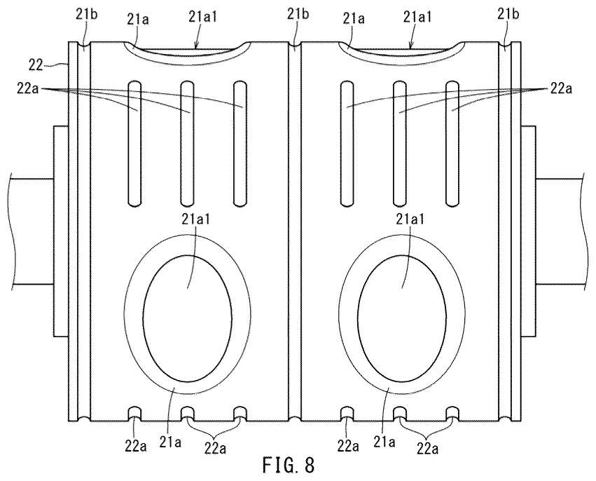

Referring to FIG. 8, a first modification of the first embodiment will be described. In the first modification, a mold roller 22 is used instead of the mold roller 21. In addition to the female mold 21a and the circumferential groove 21b, a plurality of long grooves 22a are formed in the outer peripheral surface of the mold roller 22. Each of the long grooves 22a is a discontinuous groove extending circumferentially (in the circumferential direction) on the outer peripheral surface of the mold roller 22 and having two end points. More specifically, three of the long grooves 22a are formed between the female molds 21a that are adjacent to each other in the circumferential direction of the mold roller 22.

In other words, the number of the long grooves 22a formed in the mold roller 22 is “18”. Each of the long grooves 22a, like the circumferential groove 21b, is also referred to as a “surface concave portion”. Since the long grooves 22a are formed on the mold roller 22, three elongated protrusions (not shown) between the adjacent convex portions Ca in the extending direction are formed in the noodle band Ns, after being pressed (rolled) by the mold roller 22 and the press roller 23. Each of the elongated protrusions has a substantially semi-cylindrical shape, extending in the extending direction with both end points. The cutter 52 cuts off each region of the noodle band Ns that includes the convex portion Ca but does not include the elongated protrusion as the noodle skin piece Np.

### Second Modification of First Embodiment

A second modification of the first embodiment will be described. The controller 6 described above, when the rotational angle θo of the mold roller 21 becomes equal to one the configured rotational angles, activates the cutting apparatuses 4 corresponding to that configured rotational angle. In contrast, a controller 6a according to the second modification, when one of three configured times has elapsed after the rotational angle θo becomes equal to a reference angle (for example, θo=0°), activates the cutting apparatuses 4 corresponding to that configured time. Each of the configured times may be configured in the controller 6a by an operator.

For example, when the configured time corresponding to the front cutting apparatus 41 has elapsed after the rotational angle θo becomes equal to the reference angle, the controller 6a switches the electric motor 54 of the front cutting apparatus 41 to the operating state, rotating the cutter 52 of the front cutting apparatus 41 by 180°. Similarly, when the configured time corresponding to the middle cutting apparatus 42 or the rear cutting apparatus 43 has elapsed after the rotational angle θo becomes equal to the reference angle, the controller 6a switches the electric motor 54 corresponding to that configured time to the operating state, rotating the cutter 52 corresponding to that configured time by 180°.

### Second Embodiment

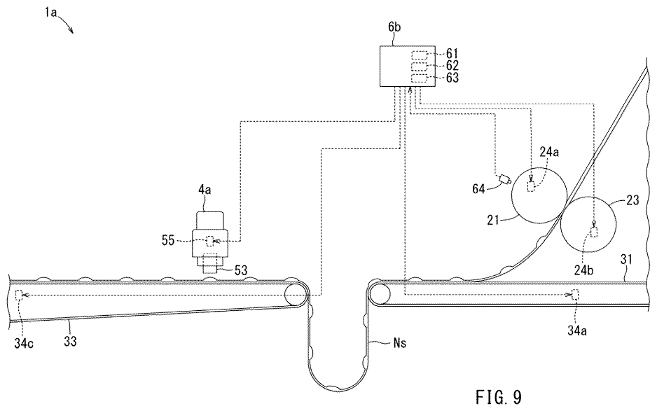

A second embodiment will be described with reference to FIG. 9. FIG. 9 schematically illustrates the noodle skin piece producing apparatus 1a (also simply referred to as the producing apparatus 1a) according to the second embodiment. Instead of the conveyor apparatus 32, the cutting apparatuses 4, and the controller 6 described above, the producing apparatus 1a includes a conveyor apparatus 33, a cutting apparatus 4a, and a controller 6b. While the conveyor apparatus 32 was controlled to operate continuously, the conveyor apparatus 33 is controlled by the controller 6b to operate intermittently. The conveyor apparatus 33 is driven by an electric motor 34c. In addition, while the cutting apparatuses 4 include the rotating cutters as the cutters 52, the cutting apparatus 4a includes punch cutters as cutters 53. Hereinafter, these differences will be mainly described.

The cutting apparatus 4a includes two of the cutters 53 arranged in the width direction of the noodle band Ns. FIG. 9 shows only one of the cutters 53, which is located closer to the viewer's perspective as seen in FIG. 9. The cutters 53 are supported so as to be movable in the vertical direction, which is perpendicular to the noodle band Ns on the conveyor apparatus 33. The vertical direction is also the thickness direction of the noodle band Ns. The vertical position of the cutters 53 is adjusted by the rotation of an electric motor 55, which is included in the cutting apparatus 4a and controlled by the controller 6b. A drive force transmission mechanism that converts the rotation of the electric motor 55 into movement of the cutters 53 in the vertical direction is omitted from illustration and description. The cutter 53 is also referred to as the “separating cutter” for convenience.

When the pair of the cutters 53 moves downward and toward the noodle band Ns, the tip portion (i.e., the cutting edge) of the cutter 53 reaches the noodle band Ns. As a result, each region containing the pair of the convex portions Ca is cut off as the noodle skin pieces Np. The noodle skin piece Np cut off from the noodle band Ns immediately after being cut by the cutter 53 has a shape similar to that of the noodle skin piece Np shown in FIG. 5(b). In other words, the tip portion of the cutter 53 has a substantially elliptical cylindrical shape.

The controller 6b, similar to the controller 6 of the first embodiment, continuously operates the conveyor apparatus 31 in accordance with the rotational speeds of the mold roller 21 and the press roller 23. The conveyor apparatus 31 is also referred to as the “first conveyor apparatus” for convenience. On the other hand, the controller 6b temporarily stops the conveyor apparatus 33 while the cutters 53 move downward and upward to cut off the noodle skin pieces Np from the noodle band Ns. That is, the controller 6b intermittently drives the conveyor apparatus 33. The conveyor apparatus 33 is also referred to as the “second conveyor apparatus” for convenience' sake.

More specifically, when two of the convex portions Ca arranged in the width direction of the noodle band Ns reach directly below the two of the cutters 53 due to the operation of the conveyor apparatus 33, the controller 6b stops the conveyor apparatus 33. Subsequently, the controller 6b moves the pair of cutters 53 downward to cut off two noodle skin pieces Np from the noodle band Ns. Afterwards, the controller 6b moves the pair of cutters 53 upward to separate them from the noodle band Ns. Subsequently, the controller 6b restarts the operation of the conveyor apparatus 33.

As having been described above, according to the producing apparatus 1 with the mold roller 21, the pressure acting on the noodle band Ns, during rolling (pressing) by the mold roller 21 and the press roller 23 to form the convex portions Ca, becomes smaller because of the circumferential grooves 21b formed on the mold roller 21, as compared to a case where the circumferential groove 21b is not formed on the mold roller 21. Therefore, the occurrence of unintended deformation in the noodle band Ns (specifically, the formation of wrinkles in the noodle band Ns and serpentine deformation in the width direction of the noodle band Ns) may be suppressed.

Similarly, according to the producing apparatus 1 with the mold roller 22, the pressure acting on the noodle band Ns, during rolling by the mold roller 22 and the press roller 23 to form the convex portions Ca, may become additionally smaller because of the circumferential grooves 21b and the long grooves 22a formed in the mold roller 22. Therefore, the occurrence of unintended deformation in the noodle band Ns may be suppressed more reliably. In other words, according to the producing apparatus 1, 1a, the likelihood of producing the noodle skin pieces Np with an intended shape (for example, the noodle skin pieces Np with no wrinkles on the surface and having a substantially circular shape when viewed from above) can be increased. That is, according to the producing apparatus 1, 1a, the yield rate in producing the noodle skin pieces Np may be improved.

In addition, since the bolts are used to secure the cutter 52 to its rotational shaft 51, it can be easily detached from the rotational shaft 51. This allows for relatively simple maintenance, such as regrinding the cutting edge, and replacement of the cutter 52 within producing apparatus 1. If it is difficult to repair the cutter 52, it is possible that the cutter 52 which is not suitable for the noodle band Ns being conveyed on the conveyor apparatus 32 will continue to be used. Consequently, there will be a high possibility, due to using the cutter 52 which is not in a proper status, that deformation will occur in the noodle skin piece Np which is cut off by that cutter 52 from the noodle band Ns, or that the surface of the conveyor apparatus 32 will be damaged by the tip portion of that cutter 52 during its rotation. On the other hand, the cutter 52, which is detachably fixed to the rotational shaft 51, facilitates easier repair of the cutter 52. This can contribute to reducing the possibility of producing noodle skin pieces Np with unintended shapes.

Furthermore, since the controller 6 switches one of the cutting apparatuses 4 to the operating state when the rotational angle θo becomes equal to the configured rotational angle corresponding to that one of the cutting apparatuses 4, it becomes possible to cut off the appropriate region within the noodle band Ns as the noodle skin piece Np using the cutting apparatuses 4. In other words, the operator can adjust regions in the noodle band Ns to be cut off as the noodle skin pieces Np by adjusting the configured rotational angles stored in the controller 6. For example, if the contraction ratio of the noodle band Ns during the period from the timing to be pressed by the mold roller 21 and the press roller 23 to the timing to reach the positions corresponding to the cutting apparatuses 4 changes, due to changes in the moisture content and temperature of the noodle band Ns, the operator can change the configured rotational angles based on the change in the contraction ratio. Similarly, the operator can adjust the regions to be cut off as noodle skin pieces Np from the noodle band Ns by adjusting the configured times stored in the controller 6a. This may reduce the possibility of producing the noodle skin pieces Np with unintended shapes.

In addition, in the producing apparatus 1a, since the conveyor apparatus 33 is stopped when the cutters 53 cut off the noodle skin pieces Np from the noodle band Ns, the occurrence of the noodle skin pieces Np with unintended shapes is suppressed.

The various examples described above in detail with reference to the attached drawings are intended to be representative of the present disclosure and are thus non-limiting embodiments. The detailed description is intended to teach a person of skill in the art to make, use and/or practice various aspects of the present teachings, and thus does not limit the scope of the disclosure in any manner. Furthermore, each of the additional features and teachings disclosed above may be applied and/or used separately or with other features and teachings in any combination thereof, to provide an improved producing apparatus, and/or methods of making and using the same.

For example, the surface concave portions formed on the mold rollers 21-22 may differ from the above-described surface concave portions. As one example, the surface concave portions may include, instead of the circumferential grooves 21b, a plurality of circumferential recesses and/or long grooves arranged annularly around the axis line La. In addition, the surface concave portions may include a plurality of circular-shaped recesses positioned between the female molds 21a that are adjacent to each other in the circumferential direction of the mold rollers. Furthermore, the surface concave portions may include long grooves disposed between the female molds 21a that are adjacent to each other in the circumferential direction of the mold rollers 21-22 and inclined relative to the circumferential direction.

In addition, while the number of the female molds 21a formed on the mold rollers 21-22 was “6”, the number of the female molds 21a may be appropriately changed. Furthermore, while the number of the female molds 21a arranged in the width direction was “2”, the number of the female molds 21a arranged in the width direction may be “1” or “3” and so on. Alternatively, the female molds 21a may be arranged such that “one of the female molds 21a” and “two of the female molds 21a adjacent to each other in the width direction” are adjacent to each other in the circumferential direction of the mold rollers 21-22.

In addition, the cutting apparatuses 4 according to the first embodiment include the front cutting apparatus 41, the middle cutting apparatus 42, and the rear cutting apparatus 43, but the number of cutting apparatuses 4 may differ from “3”. For example, the number of cutting apparatuses 4 may be “1” or “4” and so on. On the other hand, according to the producing apparatus 1a of the second embodiment, the number of the cutting apparatus 4a is “one”, but the producing apparatus 1a may include a plurality of the cutting apparatus 4a.

In addition, in the producing apparatus 1, 1a, the rotational angle sensor 64 (i.e., the angle acquisition part) acquires the rotational angle θo (i.e., the angle correlation value). Alternatively, a rotary encoder that outputs a pulse signal each time the mold rollers 21-22 rotate by a predetermined angle may be used as the angle acquisition part. In this case, the pulse signal itself or a number of the pulses within a predetermined time period output by the rotary encoder corresponds to the angle correlation value.

In addition, the cutters 52-53 cut off the elliptical region including the convex portion Ca in the noodle band Ns as the noodle skin piece Np, but the cutters 52-53 may be configured to cut off an oblong or oblate region including the convex portion Ca in the noodle band Ns as the noodle skin piece Np.

In addition, the controllers 6, 6a-6b may be located away from the producing apparatus 1, 1a. For example, the controllers 6, 6a-6b may be implemented in a server apparatus accessible via the Internet.

What is claimed is:

1. A noodle skin piece producing apparatus comprising:
a mold roller having an substantially cylindrical-shaped outer peripheral surface and configured to rotate about an axis line of the cylindrical shape, wherein the outer peripheral surface includes a female mold configured to form a convex portion in a noodle band when the outer peripheral surface is pressed against the noodle band;
at least one conveyor apparatus configured to convey the noodle band having the convex portion formed therein; and
a separating cutter configured to cut off a region of the noodle band including the convex portion conveyed by the at least one conveyor apparatus as a noodle skin piece,
wherein the outer peripheral surface of the mold roller includes a surface concave portion recessed radially in a region distinct from the female mold, the surface concave portion being configured to receive a portion of the noodle band to reduce pressure applied to the noodle band.

2. The noodle skin piece producing apparatus according to claim 1, wherein the surface concave portion includes a circumferential groove centered on the axis line of the mold roller.

3. The noodle skin piece producing apparatus according to claim 1, wherein the separating cutter is detachably fixed to a rotational shaft, its cutting edge contacting the noodle band during rotation with the rotational shaft.

4. The noodle skin piece producing apparatus according to claim 3, wherein the separating cutter is composed of hardened steel material, its cutting edge formed by grinding process.

5. The noodle skin piece producing apparatus according to claim 3, further comprising:
an angle acquisition part for acquiring an angle correlation value having a correlation with a rotational angle of the mold roller; and
a controller implemented by at least one programmed processor and configured to control the rotational angle of the separating cutter in accordance with the angle correlation value.

6. The noodle skin piece producing apparatus according to claim 1, wherein the conveyor apparatuses include a first conveyor apparatus for conveying the noodle band in accordance with the rotation of the mold roller, and a second conveyor apparatus positioned downward from the first conveyor apparatus, the separating cutter moving in the thickness direction of the noodle band on the second conveyor apparatus during operation stop of the second conveyor apparatus such that the cutting edge of the separating cutter contacts the noodle band.

7. The noodle skin piece producing apparatus according to claim 1, wherein the female mold has an elliptical shape in a plan view having a length in an extending direction of the noodle band that is greater than a length in a width direction of the noodle band to compensate for shrinkage of the noddle band.

8. The noodle skin piece producing apparatus according to claim 1, further comprising: a press roller rotatably supported adjacent to the mold roller with a predetermined gap therebetween, wherein the mold roller and the press roller are configured to rotate in opposite directions to roll the noodle band forward while pressing the outer peripheral surface of the mold roller against the noodle band.

9. The noodle skin piece producing apparatus according to claim 5, wherein the controller is configured to:
switch the separating cutter to an operating state when the angle correlation value corresponds to a position of the convex portion on the noodle band; and
switch the separating cutter to a stopped state after the separating cutter has rotated by 180 degrees.

10. The noodle skin piece producing apparatus according to claim 1, wherein the surface concave portion includes a plurality of discontinuous long grooves extending in the circumferential direction, wherein each of the plurality of discontinuous long groove has two closed end points, and wherein the plurality of discontinuous long grooves are disposed between adjacent female molds in the circumferential direction.

11. The noodle skin piece producing apparatus according to claim 1, further comprising:
a first powder dispersing apparatus configured to disperse powder onto the noodle band before the noodle band is pressed by the mold roller; and
a second powder dispersing apparatus configured to disperse powder onto the at least one conveyor apparatus before the noodle band is placed thereon to prevent adhesion.

12. The noodle skin piece producing apparatus according to claim 7, wherein a ratio of the length in the extending direction to the length in the width direction defines a first ellipticity ratio greater than 1, and wherein the female mold is configured such that the first ellipticity ratio reduces to a second ellipticity ratio of approximately 1 after the noodle skin piece is cut off and shrinks, thereby resulting in a substantially circular noodle skin piece.

13. A noodle skin piece producing apparatus, comprising:
a mold roller having a substantially cylindrical outer peripheral surface and rotating about an axis line, wherein the outer peripheral surface includes a female mold configured to form a convex portion in a noodle band and a surface concave portion recessed in a region distinct from the female mold;
a first conveyor apparatus configured to convey the noodle band continuously in accordance with a rotation of the mold roller;
a second conveyor apparatus disposed downstream of the first conveyor apparatus and configured to convey the noodle band intermittently;
a separating cutter supported movably in a thickness direction of the noodle band above the second conveyor apparatus; and a controller configured to stop the second conveyor apparatus when the convex portion is positioned below the separating cutter and to move the separating cutter downward to cut off a region of the noodle band including the convex portion as a noodle skin piece.

14. The noodle skin piece producing apparatus according to claim 13, wherein the first conveyor apparatus and the second conveyor apparatus are spaced apart from each other in a conveying direction to define a buffering gap therebetween, and wherein the buffering gap being configured to accommodate a slack portion of the noodle band suspended therein to compensate for a speed difference between the continuous conveyance of the first conveyor apparatus and the intermittent conveyance of the second conveyor apparatus.

15. The noodle skin piece producing apparatus according to claim 13, wherein the separating cutter comprises a cutting blade that has substantially elliptical cylindrical shape configured to cut off the noodle skin piece into an elliptical shape.

16. The noodle skin piece producing apparatus according to claim 13, wherein the separating cutter comprises a pair of cutter units arranged side-by-side in a width direction of the noodle band perpendicular to a conveying direction, and wherein the controller is configured to stop the second conveyor apparatus when a pair of convex portions arranged in the width direction of the noodle band are aligned vertically with the pair of cutter units.

17. A noodle skin piece producing apparatus, comprising:
a mold roller configured to rotate and press against a noodle band, wherein the mold roller has a female mold configured to form a convex portion in the noodle band; and
a separating cutter configured to cut off a region of the noodle band surrounding the convex portion as a noodle skin piece, wherein the female mold has an elliptical opening shape defined by a first dimension along a circumferential direction of the mold roller and a second dimension along an axial direction of the mold roller, and wherein the first dimension being greater than the second dimension to compensate for a contraction of the noodle band that occurs after the convex portion is formed.

18. The noodle skin piece producing apparatus according to claim 17, wherein the female mold is configured with an ellipticity ratio greater than 1 such that the convex portion formed in the noodle band shrinks over time to approach a substantially circular shape.

19. The noodle skin piece producing apparatus according to claim 17, wherein the separating cutter comprises a rotary cutter that has a cutting blade with an elliptical profile corresponding to the elliptical opening shape of the female mold, and wherein the separating cutter is configured to cut the noodle band before the convex portion fully shrinks to a circular shape.
